(19) United States
(12) Patent Application Publication
(10) Pub. No.: US 2006/0273274 A1
(43) Pub. Date: Dec. 7, 2006

(54) Electromagnetic fuel injection valve

(76) Inventor: Takahiro Nagaoka, Miyagi (JP)

Correspondence Address: ARENT FOX PLLC, 1050 CONNECTICUT AVENUE, N.W., SUITE 400, WASHINGTON, DC, 20036, US

(21) Appl. No.: 10/548,603

(22) PCT Filed: Mar. 26, 2004
(86) PCT No.: PCT/JP04/04248

§ 371 Date: Aug. 9, 2006

(30) Foreign Application Priority Data
Mar. 31, 2003 (JP) 2003-096012

(51) Int. Cl. F16K 31/02

(52) U.S. Cl. 251/129.18; 239/585.1; 251/129.21

(57) ABSTRACT

An electromagnetic fuel injection valve is provided that includes a fuel inlet tube (26) extending from an outer end of a hollow fixed core (5), and a retainer pipe (23) that is inserted from the fuel inlet tube (26) into a hollow portion (21) of the fixed core (5) and supports a fixed end of a valve spring (22). The fuel inlet tube (26) is formed from a high hardness magnetic material, a retainer pipe 23-facing portion of the fuel inlet tube (26) is heated so as to form a softened region A, and this softened region A of the fuel inlet tube (26) is crimped toward the retainer pipe (23) so as to fix the retainer pipe (23) to the fuel inlet tube (26). In this way, even when the fuel inlet tube is formed from a high hardness magnetic material, the retainer pipe can be reliably fixed to the fuel inlet tube by crimping.

### FIELD OF THE INVENTION

The present invention relates to an electromagnetic fuel injection valve used mainly in a fuel supply system of an internal combustion engine and, in particular, to an improvement of an electromagnetic fuel injection valve that includes a hollow fixed core, a fuel inlet tube extending from an outer end of the fixed core, a valve assembly having a movable core disposed so as to oppose the fixed core, a valve spring that is housed within a hollow portion of the fixed core and urges the valve assembly in a valve-closing direction, and a retainer pipe that is inserted from the fuel inlet tube into the hollow portion of the fixed core and supports a fixed end of the valve spring.

### BACKGROUND ART

It is conventionally known that, in such an electromagnetic fuel injection valve, a set load of the valve spring is adjusted by changing the depth to which the retainer pipe is inserted into the fuel inlet tube. Furthermore, as means for fixing the retainer pipe after the adjustment, means for press-fitting the retainer pipe into the fuel inlet tube (see Patent Document 1) and means for applying a crimping force to an outer peripheral face of the fuel inlet tube so as to impart plastic deformation are already known.

[Patent Document 1] Japanese Patent Application Laid-open No. 2002-4013.

However, the former means has poor productivity since it requires skill to finely adjust the depth to which the retainer pipe is press-fitted into the fuel inlet tube. The productivity of the latter means is good since the insertion depth can be adjusted easily by inserting the retainer pipe into the fuel inlet tube with a clearance fit, and crimping of the fuel inlet tube after the adjustment of the set load of the valve spring is relatively easy, but it is limited to cases where the fuel inlet tube is capable of being plastically deformed. Therefore, when the fuel inlet tube is molded from a high hardness magnetic material integrally with magnetic path-forming members such as a fixed core and a yoke, the latter means is unsuitable.

### DISCLOSURE OF THE INVENTION

The present invention has been achieved under the above-mentioned circumstances, and it is an object thereof to provide an electromagnetic fuel injection valve with high productivity by enabling a retainer pipe to be fixed to a fuel inlet tube by crimping even when the fuel inlet tube is formed from a high hardness magnetic material.

In order to attain this object, in accordance with a first aspect of the present invention, there is provided an electromagnetic fuel injection valve that includes a hollow fixed core, a fuel inlet tube extending from an outer end of the fixed core, a valve assembly having a movable core disposed so as to oppose the fixed core, a valve spring that is housed within a hollow portion of the fixed core and urges the valve assembly in a valve-closing direction, and a retainer pipe that is inserted from the fuel inlet tube into the hollow portion of the fixed core and supports a fixed end of the valve spring, characterized in that the fuel inlet tube is formed from a high hardness magnetic material, a retainer pipe-facing portion of the fuel inlet tube is heated so as to form a softened region, and the softened region of the fuel inlet tube is crimped toward the retainer pipe so as to fix the retainer pipe to the fuel inlet tube.

In accordance with this first aspect, even though the fuel inlet tube is made of the high hardness magnetic material, the softened region can be crimped. Therefore, making adjustment of the insertion depth easy by inserting the retainer pipe into the fuel inlet tube with a clearance fit enables the set load of the valve spring to be adjusted easily, and crimping the softened region subsequent to the adjustment enables the retainer pipe to be fixed to the fuel inlet tube, thereby improving the productivity.

Furthermore, in addition to the first aspect, in accordance with a second aspect of the present invention, there is provided an electromagnetic fuel injection valve wherein the softened region has an HRC hardness of 20 or less.

In accordance with this second aspect, the softened region can have a degree of constriction of about 60% or higher, and fixing of the retainer pipe to the fuel inlet tube by crimping can be carried out easily and reliably.

Moreover, in addition to the first or second aspect, in accordance with a third aspect of the present invention, there is provided an electromagnetic fuel injection valve wherein the fuel inlet tube and a magnetic path-forming member extending therefrom are molded integrally from a high hardness magnetic material, and the high hardness magnetic material is an alloy containing 10 to 20% by weight of Cr, 0.1% by weight of Si, 1% by weight or more of at least one of Al and Ni, and ferrite Fe, Mn, C, P, and S as the remainder, the total of Al and Ni being 1.15 to 6% by weight.

In accordance with this third aspect, the magnetic path-forming member, which has good magnetic properties, a high HRC hardness of 20 to 40 without subjecting it to a surface hardening treatment, and excellent abrasion resistance, can be obtained together with the fuel inlet tube at low cost.

The above-mentioned object, other objects, characteristics, and advantages of the present invention will become apparent from an explanation of a preferred embodiment that will be described in detail below with reference to the attached drawings.

### BRIEF DESCRIPTION OF THE DRAWINGS

FIG. 1 is a vertical sectional view of an electromagnetic fuel injection valve for an internal combustion engine related to an embodiment of the present invention;

FIG. 2 is an enlarged view of a part 2 of FIG. 1;

FIG. 3 is a graph showing relationships between crimped join quality and the hardness and the degree of constriction of a softened region of a fuel inlet tube of the electromagnetic fuel injection valve; and

FIG. 4 is a view of the microscopic structure of an area around the boundary between a high hardness region and the softened region of the fuel inlet tube.

### DESCRIPTION OF PREFERRED EMBODIMENTS

A preferred embodiment of the present invention is explained below with reference to the attached drawings.

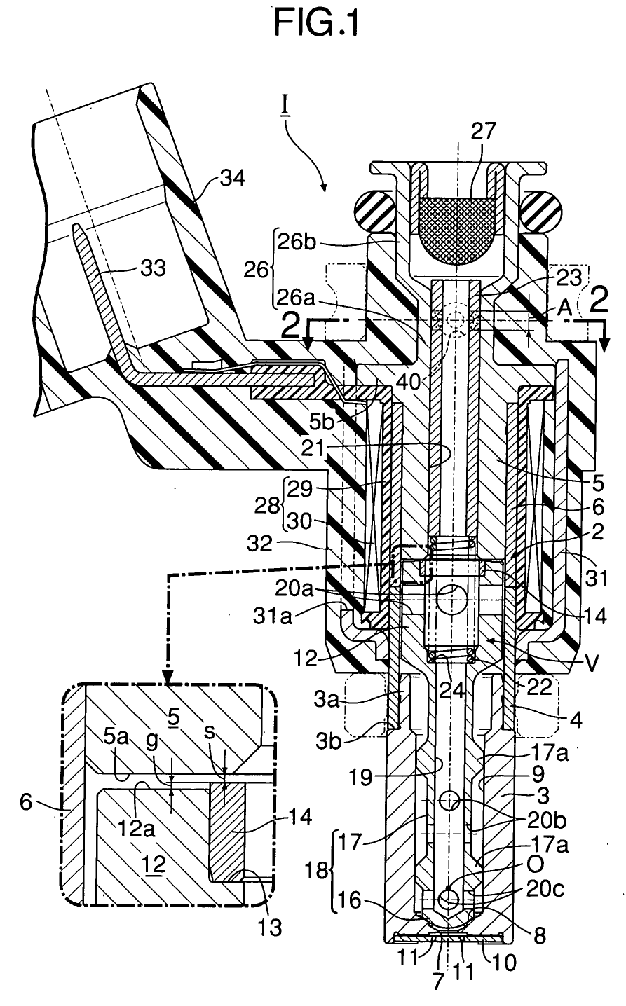

In FIG. 1, a valve housing 2 of an electromagnetic fuel injection valve I for an internal combustion engine is formed from a cylindrical valve seat member 3 having a valve seat 8 at its front end, a magnetic cylinder 4 coaxially joined to a rear end section of the valve seat member 3, and a nonmagnetic cylinder 6 coaxially joined to the rear end of the magnetic cylinder 4.

The valve seat member 3 has on its rear end section a linking tubular portion 3a that projects, with an annular shoulder portion 3b, toward the magnetic cylinder 4 from an outer peripheral face of the valve seat member 3. By press-fitting this linking tubular portion 3a in the inner peripheral face of the front end portion of the magnetic cylinder 4 so as to make the front end face of the magnetic cylinder 4 abut against the annular shoulder portion 3b, the valve seat member 3 and the magnetic cylinder 4 are joined to each other coaxially with a liquid-tight join. The magnetic cylinder 4 and the nonmagnetic cylinder 6 are joined to each other coaxially with a liquid-tight join by abutting opposing end faces against each other and laser beam welding along the entire periphery.

The valve seat member 3 includes a valve opening 7 opening on its front end face, a cone-shaped valve seat 8 extending from the inner end of the valve opening 7, and a cylindrical guide hole 9 extending from a large diameter portion of the valve seat 8. Welded to the front end face of the valve seat member 3 with a liquid-tight weld is the entire periphery of a steel injector plate 10 having a plurality of fuel injection holes 11 communicating with the valve opening 7.

A hollow cylindrical fixed core 5 is fixed in a liquid-tight manner by press-fitting into the inner peripheral face of the nonmagnetic cylinder 6 from the rear end side thereof. In this arrangement, a part of the front end portion of the nonmagnetic cylinder 6 does not have the fixed core 5 fitted thereinto, and a valve assembly V is housed within the valve housing 2 extending from that part to the valve seat member 3.

The valve assembly V is formed from a valve body 18 and a movable core 12. The valve body 18 includes a hemispherical valve portion 16 for opening and closing the valve opening 7 in corporation with the valve seat 8, and a valve stem portion 17 supporting the valve portion 16. The movable core 12 is connected to the valve stem portion 17, extends from the magnetic cylinder 4 into the nonmagnetic cylinder 6, and is inserted into these cylinders so as to coaxially oppose the fixed core 5. The valve stem portion 17 is formed so as to have a smaller diameter than that of the guide hole 9, and a pair of front and rear journal portions 17a are integrally formed on the outer periphery of the valve stem portion 17 so that the journal portions 17a project radially outward and are supported slidably on the inner peripheral face of the guide hole 9. In this arrangement, the journal portions 17a are disposed so as to form as large a gap as possible in the axial direction.

The valve assembly V is provided with a lengthwise hole 19, a plurality of first lateral holes 20a, a plurality of second lateral holes 20b, and a plurality of third lateral holes 20c. The lengthwise hole 19 extends from the rear end face of the movable core 12 to beyond the center O of the sphere of the hemispherical valve portion 16 and is blocked; the plurality of first lateral holes 20a provide communication between the lengthwise hole 19 and the outer periphery of the movable core 12, the plurality of second lateral holes 20b provide communication between the lengthwise hole 19 and the outer peripheral face of the valve stem portion 17 between the journal portions 17a, and the plurality of third lateral holes 20c provide communication between the lengthwise hole 19 and the outer periphery of the valve stem portion 17 that is toward the valve portion 16 relative to the front-side journal portion 17a. In this arrangement, the third lateral holes 20c are desirably disposed forward of the center O of the sphere of the valve portion 16, and the front-side journal portion 17a is desirably disposed as close as possible to the center O of sphere of the valve portion 16.

An annular spring seat 24 facing the fixed core 5 side is formed partway along the lengthwise hole 19.

The fixed core 5 has a hollow portion 21 communicating with the lengthwise hole 19 of the movable core 12, and has a fuel inlet tube 26 integrally connected to the rear end of the fixed core 5, the hollow portion 21 communicating with the interior of the fuel inlet tube 26. The fuel inlet tube 26 is formed from a reduced-diameter portion 26a extending from the rear end of the fixed core 5, and an enlarged-diameter portion 26b extending from the reduced-diameter portion 26a. A valve spring 22 is provided in compression between the spring seat 24 and a retainer pipe 23 inserted and fixed into the hollow portion 21 from the reduced-diameter portion 26a, the valve spring 22 urging the movable core 12 in a direction to close the valve body 18. In this arrangement, the set load of the valve spring 22 is adjusted by the depth to which the retainer pipe 23 is inserted into the hollow portion 21. The adjustment of the set load will be explained later.

A fuel filter 27 is mounted in the enlarged-diameter portion 26b of the fuel inlet tube 26.

In the valve assembly V, a mating recess 13 is formed on the attracting face 12a of the movable core 12 facing the attracting face 5a of the fixed core 5, and a collar-shaped stopper element 14 surrounding the valve spring 22 is fixed into the mating recess 13 by press-fitting, or is fitted and then fixed into the mating recess 13 by welding or crimping. The stopper element 14 is made of a nonmagnetic material such as, for example, JIS SUS304.

The stopper element 14 projects from the attracting face 12a of the movable core 12, and is normally disposed so as to oppose the attracting face 5a of the fixed core 5 across a gap s corresponding to a valve-opening stroke of the valve body 18. An amount a of protrusion of the stopper element 14 relative to the attracting face 12a corresponds to an air gap formed between the attracting faces 5a and 12a of the two cores 5 and 12 when the movable core 12 is attracted by the fixed core 5 upon energization by a coil 30 and the stopper element 14 of the movable core 12 abuts against the attracting face 5a of the fixed core 5.

A coil assembly 28 is fitted onto the outer periphery of the valve housing 2 so as to correspond to the fixed core 5 and the movable core 12. This coil assembly 28 is formed from a bobbin 29 and a coil 30, the bobbin 29 being fitted onto the outer peripheral faces of the rear end section of the magnetic cylinder 4 and the whole of the nonmagnetic cylinder 6, and the coil 30 being wound around the bobbin 29. The front end of a coil housing 31 surrounding the coil assembly 28 is welded to the outer peripheral face of the magnetic cylinder 4, and the rear end thereof is welded to the outer peripheral face of a yoke 5b that projects in a flange shape from the outer periphery of a rear end section of the fixed core 5. The coil housing 31 is cylindrical and has an axially extending slit 31 a formed on one side thereof.

The coil housing 31, the coil assembly 28, the fixed core 5, and the front half of the fuel inlet tube 26 are sealed in by a synthetic resin cover 32 by injection molding. In this arrangement, the coil housing 31 is filled with the cover 32 through the slit 31a. A coupler 34 housing a connection terminal 33 connected to the coil 30 is integrally joined to a middle section of the cover 32.

The fuel inlet tube 26 is formed integrally with the fixed core 5 and the yoke 5b from a high hardness ferrite magnetic material and, specifically, is formed by machining an alloy having the following composition.

Cr . . . 10 to 20% by weight

Si . . . 0.1% by weight

Al and Ni . . . both included, at least one thereof being 1% by weight or more, and the total thereof being 1.15 to 6% by weight

Remainder . . . ferrite Fe and, as impurities, Mn, C, P, and S

In this alloy, the total of Al and Ni being 1.15 to 6% by weight contributes in particular to improvements in the abrasion resistance, the magnetic force, and the responsiveness of the fixed core 5 and the yoke 5b. That is, about 95% of the total content of Al and Ni is a precipitate, and this greatly influences the hardness, the magnetic flux density, and the volume resistivity of the fixed core 5 and the yoke 5b. It is desirable for the hardness to be high in order to obtain the abrasion resistance, for the magnetic flux density to be large in order to increase the magnetic force, and for the volume resistivity to be small in order to improve the responsiveness.

As long as the total content of Al and Ni is 1.15 to 6% by weight, the HRC hardness of the alloy is 20 to 40. This range of hardness is sufficient to impart adequate abrasion resistance to the fixed core 5 without subjecting it to any special abrasion resistance treatment such as plating after machining of the alloy. The fixed core 5 therefore requires no special abrasion resistance treatment.

When the total content of Al and Ni exceeds 6% by weight, not only does the magnetic flux density of the fixed core 5 and the yoke 5b decrease, thus making it difficult to obtain sufficient magnetic force, but also the flow of magnetic flux is delayed due to a decrease in the volume resistivity, thus reducing the responsiveness of the valve assembly V.

Therefore, by setting the total content of Al and Ni to 1.15 to 6% by weight, the abrasion resistance and the magnetic force of the fixed core 5 and the yoke 5b and the responsiveness of the valve assembly V can be made satisfactory in practice.

The Cr (10 to 20% by weight), Si (0.1% by weight), ferrite Fe and impurities Mn, C, P, and S as the remainder of the above alloy are those generally contained in a conventional core.

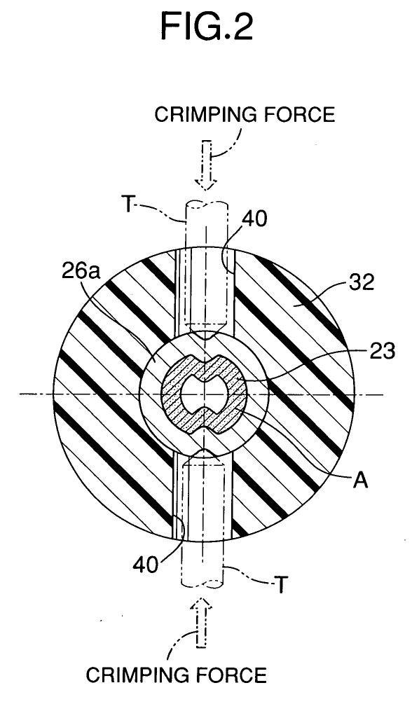

The procedure for adjusting the set load of the valve spring 22 and the structure with which the retainer pipe 23 is fixed to the fuel inlet tube 26 are explained with reference to FIG. 1 and FIG. 2.

The retainer pipe 23 is first inserted with a clearance fit into the hollow portion 21 of the fixed core 5 from the reduced-diameter portion 26a of the fuel inlet tube 26, and the set load of the valve spring 22 is adjusted by changing the insertion depth of the retainer pipe 23. After the adjustment, the reduced-diameter portion 26a is crimped radially inward so as to fix the retainer pipe 23 to the fuel inlet tube 26, but since the fuel inlet tube 26 is made of the high hardness magnetic material, if it is crimped as it is, cracks are formed in a crimped portion, thus giving poor crimping.

A retainer pipe 23-facing portion of the reduced-diameter portion 26a is therefore heated in advance so as to form a softened region A. As shown in FIG. 2, crimping tools T are inserted into a pair of coaxial tool holes 40 formed in the synthetic resin cover 32, the coaxial tool holes 40 extending from the outer peripheral face of the cover 32 to the outer peripheral face of the reduced-diameter portion 26a, and applying a crimping force to the crimping tools T so as to crimp the reduced-diameter portion 26a radially inward enables the softened region A, together with the retainer pipe 23, to easily undergo plastic deformation, thereby fixing the retainer pipe 23 to the fuel inlet tube 26.

In this way, adjustment of the set load of the valve spring 22 can be carried out easily without requiring any special skill, and after the adjustment the retainer pipe 23 can be fixed to the high hardness magnetic material fuel inlet tube 26 by crimping, thereby improving the productivity.

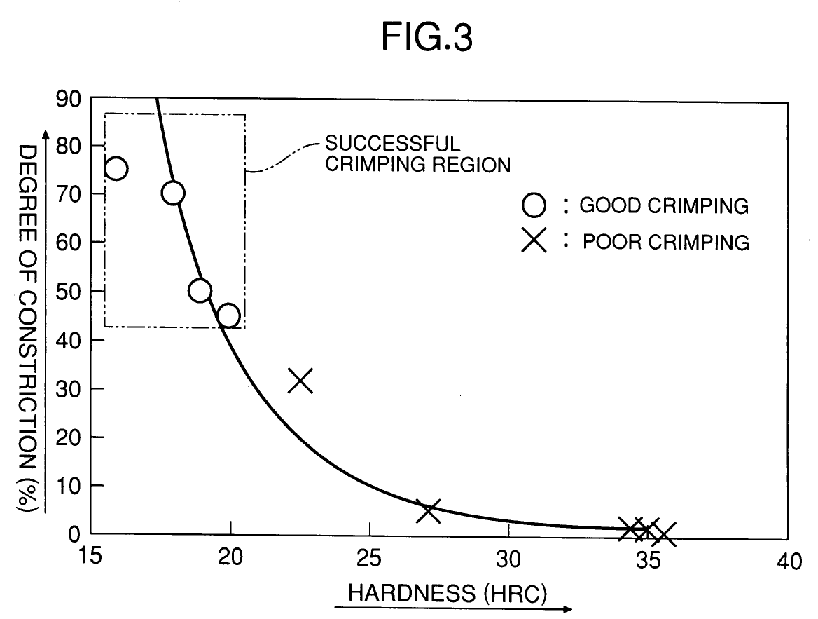

In this case, the relationships between the crimped join quality and the hardness and the degree of constriction of the softened region A were examined, and the results shown in FIG. 3 were obtained. That is, when the HRC hardness of the softened region A was 20 or less, the degree of constriction obtained was 50% or more, and joining by crimping could be carried out reliably. If the HRC hardness exceeded 20, cracks were formed in the softened region A by the crimping force, resulting in a poor crimped join. Therefore, in order to obtain a good crimped join, it is necessary for the HRC hardness of the softened region A to be 20 or less.

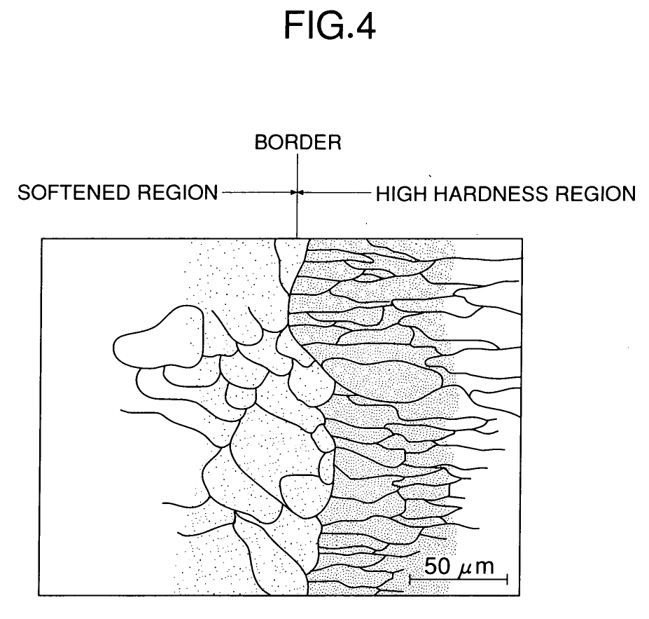

When the softened region A is formed, high frequency heating or laser beam heating is suitable. If high frequency heating or laser beam heating is carried out, as shown in FIG. 4, the border between the original high hardness region and the softened region A of the high hardness magnetic material can be made clear. Therefore, only a predetermined area that is to be subjected to crimping is made into the softened region A, thereby preventing the properties of the original high hardness magnetic material from being degraded in areas other than the area subjected to plastic processing.

In the electromagnetic fuel injection valve I thus arranged, when the coil 30 is energized by passing electricity, the magnetic flux generated thereby runs sequentially through the fixed core 5, the coil housing 31, the magnetic cylinder 4, and the movable core 12, the movable core 12 of the valve assembly V is attracted by the fixed core 5 against the set load of the valve spring 22 by virtue of this magnetic force, the valve body 18 is detached from the valve seat 8, the valve opening 7 is opened, and high-pressure fuel within the valve seat member 3 is discharged from the valve opening 7 and injected through the fuel injection holes 11 toward an engine intake valve.

During this process, the stopper element 14 fixedly fitted into the movable core 12 of the valve assembly V abuts against the attracting face 5a of the fixed core 5, thus defining the valve-opening limit for the valve body 18, and the attracting face 12a of the movable core 12 faces the attracting face 5a of the fixed core 5 across the air gap a, thereby avoiding direct contact with the fixed core 5. In particular, by dimensional management of the amount of protrusion of the stopper element 14 relative to the attracting face 12a of the movable core 12, the air gap g, can be obtained precisely and easily; this, together with the effect of the stopper element 14 being nonmagnetic, enables residual magnetization between the two cores 5 and 12 to be quickly lost when the coil 30 is de-energized, thereby improving the valve-closing responsiveness of the valve body 18.

During opening and closing operations of the valve assembly V, the valve assembly V is always maintained in an appropriate upright attitude by the pair of front and rear journal portions 17a on the valve stem portion 17 sliding against the inner peripheral face of the valve seat member 3, thereby stabilizing the fuel injection characteristics.

Since the first to third lateral holes 20a to 20c, which communicate with the lengthwise hole 19, open on the outer peripheral face of the valve assembly V, fuel that has flowed into the lengthwise hole 19 is supplied to the sliding surfaces of the journal portions 17a and the gap between the movable core 12 and the magnetic cylinder 4 via the first to third lateral holes 20a to 20c, thus enabling not only lubrication of the sliding surfaces of the journal portions 17a, but also cooling of the movable core 12 and the magnetic cylinder 4 to be carried out effectively, and thereby improving the responsiveness and the abrasion resistance of the valve assembly V.

Moreover, since the fixed core 5 is made of the high hardness ferrite magnetic material as described above, the fixed core 5 can exhibit good magnetic properties and high abrasion resistance on its own, thus contributing to improvements in the abrasion resistance of the movable core 12 and the responsiveness of the valve assembly V and thereby making the fuel injection characteristics stable over a long period of time. Furthermore, since there is no need to subject the high hardness ferrite magnetic material fixed core 5 to any special abrasion resistance treatment, the number of production steps can be reduced, and the fixed core 5 equipped with the high hardness yoke 5A can be produced together with the fuel inlet tube 26 at low cost.

Furthermore, the first lateral hole 20a, which crosses the movable core 12, can suppress the occurrence of eddy currents in the movable core 12 when the coil 30 is energized and de-energized, thereby preventing the movable core 12 from being heated due to eddy currents.

Moreover, the deep lengthwise hole 19, which extends to the vicinity of the spherical surface of the hemispherical valve portion 16, together with the first to third lateral holes 20a to 20c, function to eliminate surplus material of the valve assembly V and also function as fuel passages, thus contributing to a reduction in the weight of the valve assembly V and consequently an improvement in the responsiveness.

The present invention is not limited to the above-mentioned embodiment, and can be modified in a variety of ways without departing from the spirit and scope of the present invention.

1. An electromagnetic fuel injection valve comprising a hollow fixed core (5), a fuel inlet tube (26) extending from an outer end of the fixed core (5), a valve assembly (V) having a movable core (12) disposed so as to oppose the fixed core (5), a valve spring (22) that is housed within a hollow portion (21) of the fixed core (5) and urges the valve assembly (V) in a valve-closing direction, and a retainer pipe (23) that is inserted from the fuel inlet tube (26) into the hollow portion (21) of the fixed core (5) and supports a fixed end of the valve spring (22);
characterized in that the fuel inlet tube (26) is formed from a high hardness magnetic material, a retainer pipe (23)-facing portion of the fuel inlet tube (26) is heated so as to form a softened region (A), and the softened region (A) of the fuel inlet tube (26) is crimped toward the retainer pipe (23) so as to fix the retainer pipe (23) to the fuel inlet tube (26).

2. The electromagnetic fuel injection valve according to claim 1, wherein the softened region (A) has an HRC hardness of 20 or less.

3. The electromagnetic fuel injection valve according to claim 1 or 2, wherein the fuel inlet tube (26) and a magnetic path-forming member (5) extending therefrom are molded integrally from a high hardness magnetic material, and the high hardness magnetic material is an alloy containing 10 to 20% by weight of Cr, 0.1% by weight of Si, 1% by weight or more of at least one of Al and Ni, and ferrite Fe, Mn, C, P, and S as the remainder, the total of Al and Ni being 1.15 to 6% by weight.
